(19) United States
(12) Patent Application Publication
(10) Pub. No.: US 2009/0117323 A1
(43) Pub. Date: May 7, 2009

(54) Airtight Self-venting Composite Film for Food Packaging

(76) Inventor: David Lin, Shanhua (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/934,874

(22) Filed: Nov. 5, 2007

(51) Int. Cl. B32B 7/00; B32B 15/04; B32B 3/26

(52) U.S. Cl. 428/138

(57) ABSTRACT

An airtight self-venting composite film for food packaging device has a substrate film formed with a plurality of micro-gap regions and a sealing adhesive tape covering the plurality of micro-gap regions through an adhesive layer. The composite film is applied to a food packaging device, such containers or bags, which provides an airtight structure. In use, foodstuffs can be tightly sealed in the food packaging device to be refrigerated or frozen. When cooking the foodstuffs, the sealing adhesive tape can be optionally removed for reuse before microwaving. The food packaging device in refrigerated or frozen status is then heated up with a microwave oven without causing burst of the food packaging device when heating, for the self-venting composite film regulates the steam at high temperature and build-up high pressure.

### FIELD OF THE INVENTION

The present invention relates to an airtight self-venting composite film for food packaging, and more particularly to a composite film applied to various food packaging containers or bags for receiving frozen or refrigerated foodstuffs, the composite film adapted to be tightly sealed, and when heated by microwave oven, the composite film is able to suitably regulate the build up high-temperature pressurized steam generated by microwave heating so as to prevent the food packaging containers or bags from bursting, and retaining most of the high-temperature steam while maintaining the original flavor of the foodstuffs therein.

### BACKGROUND OF THE INVENTION

Conventionally, foods can be selectively heated by roasting, boiling, or steaming. In another aspect, cooking foods by microwave with high-energy efficiency has been developed and used more than at least 50 years. In industrialized or developed countries, based on convenience and quickness, cooking foods by microwave ovens is commonly practiced at homes, schools, restaurants, or other public places.

The principle of heating foods by microwave is that polar molecules of various compositions contained in a heated material have dipole moments. In an electromagnetic field of the microwaves, the dipole moments of the polar molecules intensely vibrate and flip to align with the electromagnetic field direction. The heated material has a damping effect capable of converting vibration energy generated by the dipole moments of the polar molecules into heat energy through frictional dissipation so as to increase internal energy and temperature of an internal system of the heated material. Generally, the more intense the dipole moments of the polar molecules are (i.e. the higher the relatively dielectric constant of the polar molecules are), the higher the conversion ratio from the microwave energy into heat energy is (i.e. the higher the temperature rising and heating of the heated material are). The relative dielectric constant of pure water in room temperature is close to 80 while that of polyethylene (PE) is 2.51. Thereby, when heating water-rich foodstuffs received in a PE packaging material by microwaves, most of microwave energy is converted into heat energy by water molecules of the water-rich foodstuffs in principle. In other words, temperature rising of a heated system is dependent on foodstuffs but not the packaging material because the packaging material only has a lower heat conversion not enough to raise temperature quickly. Furthermore, microwaves has a property of general electromagnetic waves to penetrate all portions of a heated material for uniformly heating the heated material while raising temperature of an internal system of the heated material by converting the vibration energy into heat energy by ways of frictional dissipation of the damping of the heated material. It is understood that the higher the heat conversion of molecular damping of the heated material is, the higher the temperature of the heated material is raised, and the more the well cooked material is heated. In industry and consumer society, microwaves is commonly used to heat, dry, cook, roast, bake, or sterilize a processed food, wherein the microwaves is generally selected from electromagnetic waves ranged from 915 MHz to 2450 MHz. Moreover, the relatively dielectric constant of food material and the frequency of microwave are related to the temperature of the microwave heating.

Two main problems occurring during heating and cooking foods by microwave in an open space are that foods lose water too fast, and become too dried after heated. It is because foodstuffs contain high volatile constituents with high dielectric constant, such as water, which is capable of converting microwave energy into heat energy by effect of friction under an electromagnetic field of the microwave so as to raise temperature of the foodstuffs. It is resulted in that the high volatile compositions with high vaporization absorb heat energy and quickly evaporate away from the foodstuffs, and the foodstuffs become drier to lose the original flavor thereof.

In microwave heating application, common commercial packaging material applied to microwave ovens includes wrapping film, special microwave bag, special microwaveable container, etc. The packaging material is selected from the group consisting of polyethylene (PE), polypropylene (PP), polyamide (nylon), polycarbonate (PC), polyvinyl chloride (PVC), polyvinylidene chloride (PVDC), polymethylpentene (PMP), ethylene-vinyl acetate (EVA), polyurethane (PU), Surlyn™ (Dupont ionomer), polyethylene terephthalate (PET), polyvinyl alcohol (PVA), paper, synthetic paper, glassine paper, waxed paper, ceramic, glass, and the combination thereof. The packaging material can be constructed into mono-layer structure, multi-layer structure, or foamed form.

In practical fact, based on manufacturing convenience of the packaging material formulation, plasticizer additives are commonly added into the packaging material. However, the plasticizer additives of the packaging material are directly in contact with foods during packaging, storing, transporting, or heating by microwave so that the plasticizer additives contaminate the foods to worry health of food consumers.

To overcome the problem as described above, the Food and Drug Administration (FIDA) of the United States of America and related Health Departments in most countries of the world legislate for requirement and standard regulation about food packaging material. Except for the requirement that foods can not be contaminated by the packaging material, related requirement about thermal stability and thermal degradation of the packaging material under environment at high and low temperature is included.

In recent years, because the knowledge of consumers and the socio-economic level are increasing, the consumers have higher acceptability to use microwave ovens based on higher energy efficiency, time saving, high cooking convenience, and quickly heating of the microwave ovens. In search of organoleptic quality cuisine without losing nutrients and original flavor of food, cooking by combination of microwave heating and steam boiling seems to become a common practice. In application of cooking quick frozen organic vegetables and fresh refrigerated vegetables, it can preserve various vitamins contained therein.

In another aspect, when a packed food of airtight type are heated by microwaves, a phenomenon called “air burst” may happen in a food packaging bag of the packed food because heat energy quickly raises internal air temperature and internal build up over pressure of steam at high temperature in the food packaging bag. To prevent the problem as described above, suppliers of conventional food packaging material suggest that pre-forming an opening on food packaging bags or food packaging containers before heating or cooking by microwaves so that the build up internal high temperature pressurized steam generated during heating or cooking can be suitably released to prevent the air burst phenomenon. An American corporation, Ziploc, suggests that a frozen-food zipper storage bag for frozen food which can be heated by microwaves must be pre-opened the profile as a ventilation hole thereon before heating so as to prevent the air burst phenomenon and any accident.

However, the way to use the food packaging bag causes an inner space of the food packaging bag open to atmosphere so that most of high volatile compositions of foodstuffs received in the packaging bag may be vast lost during microwave heating and the foods become too dried after heated to lose the original flavor thereof. Further, foodstuffs contained in the packaging bag contacts oxygen in the air easily through the pre-opened profile so that microorganisms grow up and insects invade. The shelf life of foodstuffs is thus hard to extend.

Conventional food packaging bag including sealed type or reclosable type like zipper bag has a sealed packing space for receiving foods. If heating the foodstuffs with the food packaging bag by microwave oven, internal temperature of the foodstuffs sealed in the food packaging bag and build up pressure of hot steam at high temperature caused by evaporation of high volatile composition of the foods increase over the time so that the build up internal steam pressure thereof may be greater than threshold limit value of tension resistance of the food packaging bag. It is resulted in that the air burst phenomenon is happened to the food packaging bag and destroys structure thereof while losing considerable water vapor and the foods become too dried after heated to lose the original flavor thereof.

In addition, cooked foodstuffs made from flour, such as steamed meat buns, boiled dumplings, spaghetti, and etc., can be heated by a steam cooker or by microwave oven if the cooked foodstuffs are covered with a wrap film. The steam cooker can heat the cooked foodstuffs and maintain its original flavor while the cooked foodstuffs may absorb too much water vapor to become loosened or soggy and losing the taste. The microwave oven can quickly heat the cooked foodstuffs covered with the wrap film, but water contained in the cooked foodstuffs may evaporate to be quickly dissipated away. At this time, because the wrap film has an impermeable property and a lower dielectric constant, the energy conversion ratio from microwave energy into heat energy of the wrap film is less than that of some compositions with high dielectric constant of the cooked foodstuffs, such as water. Thereby, the temperature of the wrap film is lower than that of the cooked foodstuffs, and the water vapor dissipated from the cooked foodstuffs tends to condense on an inner surface of the wrap film with which the cooked foodstuffs are in contact. It is resulted in that a portion of the cooked foodstuffs in contact with the wrap film absorbs too much condensed water to become loosened and soggy while the other portion thereof loses too much water to become drier and harder so that heating by the microwave oven causes the cooked foodstuffs to lose its original flavor.

To prevent the air burst phenomenon caused by raising temperature and its build up steam pressure too much during heating a sealed packaging material by microwaves, relevant development and research is continued. Various permeable materials are developed, and applied to waste water filtration, air purification, diaper, wet towel, medical packaging material, and etc., but not to food packaging material for microwave heating. Conventional manufacturing methods for permeable materials are disclosed in U.S. Pat. No. 3,378,507, No. 3,310,505, No. 3,607,793, No. 3,812,224, No. 4,247,498, No. 4,466,931, and No. 5,928,582, wherein the methods form a film made of at least two incompatible materials, and then remove one of the two materials by extraction so as to form a porous structure in the other remaining material capable of being applied to filtration and separation, such as separator application in batteries for electrolytes passing therethrough, and dialytic films for water purification or desalination process of sea water. Due to the mechanical strength of a permeable material is in inverse proportion to porosity thereof, the permeable material may still have a danger about the air burst phenomenon when it is used as a food packaging material applied to microwave heating. In another aspect, if residues of the extracted material which should be removed during extraction were not completely removed, the high dielectric constant of the residues of extracted material might form heat spots due to convert microwave energy into heat energy during microwave heating so that the permeable material would be melted in the heat spots to form holes while the high volatile compositions contained in foodstuffs vast evaporate through the holes. Thereby, the permeable material made by the methods as described above is not suitable used as food packaging material applied to microwave heating, and its manufacturing cost is high while recycling of its extraction solutions was complicated. Another conventional permeable material is disclosed in U.S. Pat. No. 5,865,926, wherein non-woven fabric or fiber fabric with high permeability are used as permeable films, but the permeable nonwoven with high manufacturing cost have a macro porous property which limits the permeable nonwoven to only be applied to diaper or wet towel, but not to food packaging material for microwave heating.

Other conventional manufacturing methods for permeable materials are disclosed in U.S. Pat. No. 3,679,540, No. 4,187,390, No. 4,350,655, No. 4,466,931, No. 4,777,073, and No. 5,340,646, wherein inorganic powder, such as CaCO₃, TiO₂, or Al₂O₃, are uniformly blended with at least one organic polymeric material, such as polyethylene, and then the mixture is extruded to form a permeable film. The mixture can be selectively processed by a coextruded die to form blown film and its converted bag; processed by a tretching tenter; or processed by an extruder. These equipments are used to stretch the extruded film to form a permeable film under a processing temperature close to a softening point temperature of the mixture. Although the permeable film made by the conventional manufacturing methods has micro porous structure, the conventional manufacturing methods has higher manufacturing cost, and more complicated processes while still having a danger about the air burst phenomenon during microwave heating to limit its practicability. Meanwhile, the inorganic powder has a low specific heat constant and a high dielectric constant so as to form heat spots to convert microwave energy into heat energy during microwave heating. It is resulted in that the permeable film would be melted within the heat spots to form holes while the high volatile compositions contained in foodstuffs would escape through the holes. It should be noted that the conventional manufacturing methods are difficult to control the consistency of porous quality of the permeable film such as elongation ratio, processing temperature, film thickness, and mixing ratio while the inorganic powder may contaminate the environment to cause a problem about environmental protection. Moreover, limit to the mixing compatibility of materials of the permeable film, the inorganic powder and the polymeric material may cause multiple phases to form an opaque permeable film. On the other hand, the conventional manufacturing methods need more complicated processes to form the permeable film. Furthermore, when the permeable film is applied as food packaging material, the inorganic powder contained therein may contaminate foodstuffs within the food packaging material via direct food contact, and generate unpleasant odors. When the permeable film is in contact with oily or alcoholic foodstuffs, the permeable film cannot prevent oil or alcohol from migrating therethrough while the permeable film absorbs the oil or alcohol therein. If the permeable film is used as a food packaging material with a pouch of oxygen scavenger, the oxygen scavenger may be covered with the oil or alcohol so as to lose its function to maintain food flavor and food freshness.

When heating or cooking a food, the food absorbs heat energy. If heating the food by microwaves, some compositions with high dielectric constant of the food such as water has a resonance effect and a high damping effect capable of converting microwave energy into heat energy for heating or cooking the food while raising internal temperature and build up steam pressure. Due to the permeable film has inorganic powders with a low specific heat, the inorganic powders may immediately form heat spots due to a converting microwave energy into heat energy during microwave heating so that the permeable film would be melted in the heat spots to form holes while a vast gaseous or liquid compositions contained in foods lose through the holes if the permeable film is used as a food packaging material. Furthermore, during accommodating foods or sterilizing under high temperature, the permeable film tends to peel off or break.

To overcome the problem about the air burst phenomenon of food packaging bags or containers, various permeable food packaging bags or containers are developed, and suitable to receive frozen foods or refrigerated foods and to be heated by microwaves without preopening the permeable food packaging bags or containers. However, the permeable food packaging bags or containers can only preserve foods at a shorter time period because those materials can not pack foods by at least one method of vacuum packaging or a process of modified atmosphere packaging (MAP) through purging with carbon dioxide (CO₂), nitrogen (N₂), or other inert gas for prolonging the shelf life of the foods. Moreover, ice burn phenomenon caused because water in foods volatilizes under a long-term period of frozen storage.

The inventor of the present invention develops various food packaging bags or containers applied to microwave heating, wherein the related core technique has been disclosed in Taiwan Patent No. 153042, No. 172945, No. 182938, and No. 201962, U.S. Pat. No. 7,077,923 and No. 7,208,215, and Japan Patent No. 3,747,004. A permeable composite film is developed and used as food packaging bag for microwave heating to improve related problems of conventional permeable material. The permeable composite film provides convenience of operation, and ensures that water and soup content can be hold inside the packaging or inside the foods without spattering onto inner walls of a microwave oven during microwave heating so as to reduce cleaning cost of the microwave oven. It is more important that the permeable composite film has a reversible permeability to automatically regulate a build-up inner steam pressure therein. Before microwave heating, the permeable composite film is in a normally substantially closed state. During microwave heating, the permeable composite film automatically regulates the build-up inner pressure of hot steam at high temperature therein to prevent the air burst to the packaging material. During cooling after stopping microwave heating, the permeable composite film restores to its normally substantially closed state. The reversible permeability about automatic regulation of the permeable composite film is in relation to the inner pressure and temperature therein so that the permeable composite film has a reusable property. The permeable composite film as described above is different from conventional food packaging bags, which must be pre-formed with an opening by a destructive operation before microwave heating.

### SUMMARY OF THE INVENTION

The present invention directs to improvement in microwaveable food packaging bags or containers so as to provide various food packaging bags or containers with a better barrier function in an airtight packing at room temperature wither in frozen or in refrigerated condition.

A primary object of the present invention is to provide an airtight self-venting composite film for food packaging application. The composite film has a substrate film provided with a plurality of micro-gap regions. An airtight film of a sealing adhesive tape has an adhesive layer coated on partial area of a surface, to cover the plurality of micro-gap regions of the substrate film. Particularly, the composite film is applied to various food packaging bags or containers for receiving frozen or refrigerated foods followed by sealing the composite film. During general transportation and storage processing, the food packaging bags or containers of the composite film maintain an airtight state and are directly frozen or refrigerated. When taking the food packaging bags or containers out of a freezer or a refrigerator, the sealing adhesive tape covered on the micro-gap regions, i.e. the self-venting section, can be optional removed before microwave beating for reuse purpose. The food packaging bags or containers are then directly heated by microwave, boiling, or steaming to prepare the food for dining so as to prevent from the air burst phenomenon, conventional food packaging bags or containers of sealed type which must be pre-pierced an opening or pre-opened before heating or cooking such as microwave heating. The invention provides a revolutionary packaging concept for frozen or registered food packaging devices with instant, convenient, reusable and energy-saving features.

The present invention is related to Taiwan Patent No. 482722, No. 522123, and No. 542812, U.S. Pat. No. 7,077,923 and No. 7,208,215 and Japan Patent No. 3,747,004, which disclose a packaging bag and how to prepare the composite film of the present invention capable of automatically regulating a build-up inner steam pressure therein. Wherein the process of the composite film is related to various integrated technologies such as impression rollers used to form specific micro gaps are mainly adapted to manufacture a substrate film which plays a critical role capable of reversibly regulating a build-up inner steam pressure in the composite film of the present invention. In operation, the stabbed structures are used to form a plurality of specific micro gaps on the substrate film. Preferably, the counts, shapes, distribution density, distribution locations of the specific micro gaps, and the thickness and materials of the substrate film can be adjusted to control the regulation degree of build-up high temperature pressurized steam through the substrate film. Moreover, the impressed structures are selected from both continuous-type impression cylinder roller sets and batch-type planar table-like impression machines, which are suitable for the impression process. The former, however, is more economical, and is more easily automated. The continuous-type impression cylinder assembly comprises an impression cylinder and one opposite cylinder. Both the cylinder roller set and planar table-like machine include an impresser and a transfer co-impresser. At least one of the two impressers comprises a plurality of fine protruding grains on the surface of the cylinder or plate (not shown). The protruding grains may be finished by at least one method as below, such as (1) by rigid wire brushes or blade sets; (2) by uniformly electroplating polygonal diamond particles or rigid equivalent particles on the surface thereof; (3) by laser engraving on rigid organic blanks, metal blanks, or ceramic blanks to form the surface with the protrusions (i.e. ceramic anilox roll); (4) by mechanical tooling or processing a metal surface with a predetermined hardness to form the protrusions followed by at least one surface hardening treatment such as high-temperature sintering and ultrasonic hardening to finish the protrusions of the metal surface; or (5) by chemically etching a metal surface via electrolysis to form the protrusions on the metal surface followed by surface hardening treatment to finish the protrusions thereof. In another aspect, the opposite cylinder or plate, i.e. the co-impresser, may be selected from metal, alloy, plastic steel or ceramic material with suitable hardness. As described above, the surface finishing process of the protrusions of the impression cylinder (or the planar impresser) can be selectively carried out by the electroplated method, the mechanical tooling method, the laser engraving method, and etc. Then, the opposite rollers or the opposite co-impresser can be used to form the plurality of micro gaps or plurality micro-gap regions on the substrate film, and the micro gaps can be selectively shaped in various configurations while providing with a suitable permeability for the substrate film. Preferably, the substrate film of the composite film finished by at least one method as described above can be processed to provide the desired heat-sealing property, self-venting function and specific designed structure. Furthermore, by means of selecting suitable materials, suitable stabbed structures or equivalent structures, and suitable environmental conditions of the surface finishing process, the composite film of the present invention can be optimized to fit the necessities of consumers. Moreover, the micro gaps of the substrate film of the composite film can be selectively distributed in various portions thereof if desired, such as entirely distributed, partially distributed, regularly distributed, or irregularly distributed, and the distribution modes and related structures of the micro gaps are flexibly dependent on selected materials of the substrate film, processing conditions, and etc.

In another aspect, the protrusions of the stabbed structures can be selectively shaped in various configurations, such as linear type, conical type, pyramidal type, cross type, and etc. After surface finishing by the stabbed structures, due to the nature of viscoelasticity and memory effect of polymeric material of the substrate film, most of the surface of the substrate film is substantially a plan except for the structure of permanent deformed regions with the micro gaps. In one preferred embodiment of the present invention, the surface of the substrate film is optionally processed by calendaring rollers capable of temperature adjustment so as to level the surface thereof to form a pseudo-planar topography with the micro gaps which substantially closed and maintain the basic configurations, such as linear type, conical type, pyramidal type, cross type, or other type like slits or grooves. The super calendaring rollers with a temperature adjustable function as described above are adapted to process the substrate film which becomes a uniformly planar structure with substantially equal thickness and fine appearance.

A first aspect of the present invention is to provide an airtight self-venting composite film for food package comprising a substrate film. A plurality of micro gaps are provided on partial area of the substrate film, wherein the geometric structure of the micro gaps being selected from various configurations with average size ranged from 0.1 micron to 10 millimeter while the adjacent opposite edges of the micro gaps are physically in contact with each other to form a normally substantially closed micro gap on the substrate film. The composite film further comprises a sealing adhesive tape to cover the plurality of micro gap regions so as to form an airtight structure. The sealing adhesive tape structurally consists of an airtight film and a adhesive layer. The adhesive layer is a striped glue section coated on partial area of one side surface of the airtight film and parallel to the direction of the sealing adhesive tape. Rest area of the surface of the airtight film is not coated with the adhesive layer for facilitating peeling the sealing adhesive tape off. The striped glue section is to attach to and cover on the distribution of the plurality of micro gaps on the substrate film. The plurality of micro gaps on the substrate film allows automatic ventilation and regulation of a build-up inner steam pressure therein. The combination of the sealing adhesive tape and the substrate forms an airtight composite film structure. Such airtight structure provides an airtight storage device for storing foodstuff and prevents foods been exposed to the air and avoids ice burn phenomenon due to water evaporation caused by storage in a dry open space at a long-term period. In addition that the food packaging device can be directly heated without pre-piercing packaging material before cooking with a microwave oven and causing air burst phenomenon, it can also extend shelf life of the foods.

For reuse of the sealing adhesive tape, the sealing adhesive tape can be optionally removed easily from the composite film by the unglued area before microwave heating. The substrate film with the plurality of micro-gap regions will dynamically regulate the build-up high temperature pressurized steam generated by heating the food packaging device in order to prevent the air burst phenomenon.

A second aspect of the present invention is to provide a composite film as a food packaging device, which is in an airtight state during transportation. Upon microwave heating, build-up high temperature pressurized steam generated by heated food is guided to be released away to the atmosphere through pressure regulating area of the plurality of micro gaps of the composite film. Meanwhile, the food packaging device maintains foodstuffs contained therein in a receiving portion thereof being efficiently heated under the build-up high temperature pressurized and rapidly circulating steam while preventing the air burst phenomenon frequently occurred to the conventional food packaging bag or container during microwave heating. In addition to application in package of foods with liquid like materials during normal transportation, the airtight structure of the food packaging device according to the present invention are capably provided in a vacuum packaging application or in a modified atmosphere packaging (MAP) application filled with inert gas, such as carbon dioxide (CO₂), nitrogen (N₂), and etc., so as to extend the expiration time of the foods. Except for being applied to food packaging materials for packaging frozen or refrigerated foodstuffs, the composite film of the present invention can also be applied to food packaging materials of airtight type for packaging various fresh foodstuffs or cooked foodstuffs to provide a long-term fresh hold effect. During cooking, the food packaging bag or container can be taken out of a freezer or refrigerator and directly heated by any cooking device, such as microwave ovens to prepare the foods for dining. With current invention, there is no need to thaw the foodstuffs; the food packaging bag or container with the foodstuffs can be directly heated by full-power operation of the heater. It saves cooking time, energy, and cost for providing heated foods without causing the kitchen greasy or losing original food flavor and nutrients preservation.

A third aspect of the present invention is to provide a food packaging material having a high permeability applied to microwave heating for solving the problems existed in the conventional food packaging materials applied to microwave heating. The food packaging material of the present invention can be selected from different predetermined functional materials dependent on necessities of consumers. The food packaging material is an environmental safe product, and can be degraded into water and carbon dioxide after incinerating to prevent any environmental pollution. Furthermore, the food packaging material will not contaminate the foods therein, and can prevent the foods from being contaminated by outer contaminants during microwave heating or cooking. Meanwhile, the food packaging material can prevent the air burst phenomenon caused by build up high temperature pressurized steam. The food packaging material manufactured by the process of the present invention can be normally used in a wider temperature range. Moreover, the specification of usage temperature, the dimension and the configuration of the food packaging material can be optimized and flexible adjusted dependent on foods and necessities of consumers.

A forth aspect of the present invention is to provide a permeable film applied to food packaging bags or containers, comprising a substrate film partially processed to form a plurality of micro-gap regions, wherein the micro-gap regions are covered with an airtight film via an adhesive layer so that an airtight structure is formed to provide an airflow barrier. When foodstuffs in the food packaging bag or container are heated to generate a build-up high temperature pressurized steam, the adhesive layer adjacent to the substrate film will be softened by the hot steam of the heated foodsstuffs. The adhesion strength will be gradually decreased, and then the airtight film will be automatically peeled from the substrate film. Furthermore, the substrate film will be expanded and deformed due to expansion caused by the pressurized hot steam so that the region with normally substantially closed micro gaps will be gradually expanded and becomes a safe pressure regulating area to prevent the air burst phenomenon caused by the build-up high temperature pressurized steam gradually generated in the food packaging bag or container during heating foodstuffs.

A fifth aspect of the present invention is to provide a sealing bag with self-venting permeability at high temperature, which is possible to be directly covered and sealed by the sealing adhesive tape to pack cooked foodstuffs and be stored under a frozen or refrigerated condition for preservation. Before dining, the food packing bag with the foodstuffs can be directly heated by a heater such as a microwave oven a short time to prepare food followed by opening the food packing bag for dining.

The structure and the technical means adopted by the present invention to achieve the above and other objects can be best understood by referring to the following detailed description of the preferred embodiments and the accompanying drawings, wherein:

### BRIEF DESCRIPTION OF THE DRAWINGS

FIG. 1 is a perspective view of a composite film applied to a food packaging container in an unsealed status according to a first embodiment of the present invention;

FIG. 2 is a perspective view of the food packaging container in a sealed status;

FIG. 3 is a cross-sectional view of the FIG. 2 taken along 30-30 line;

FIG. 4 is an illustration showing the food packaging container of FIG. 1 during heating;

FIG. 5 is a perspective view of a composite film applied to a food packaging container, having a plurality of micro gaps in another configuration;

FIG. 6 is a perspective view of a composite film applied to a food packaging bag according to a second embodiment of the present invention;

FIG. 7 is a perspective view of a composite film applied to a food packaging bag, having a plurality of micro gaps in another configuration;

FIG. 8 is a perspective view of the composite film applied to a food packaging bag according to a third embodiment of the present invention;

FIG. 9 is a perspective view of a composite film applied to a food packaging bag, having a plurality of micro gaps in another configuration; and

FIG. 10 is an illustration showing the food packaging bag of FIG. 8 during heating.

### DETAILED DESCRIPTION OF THE PREFERRED EMBODIMENTS

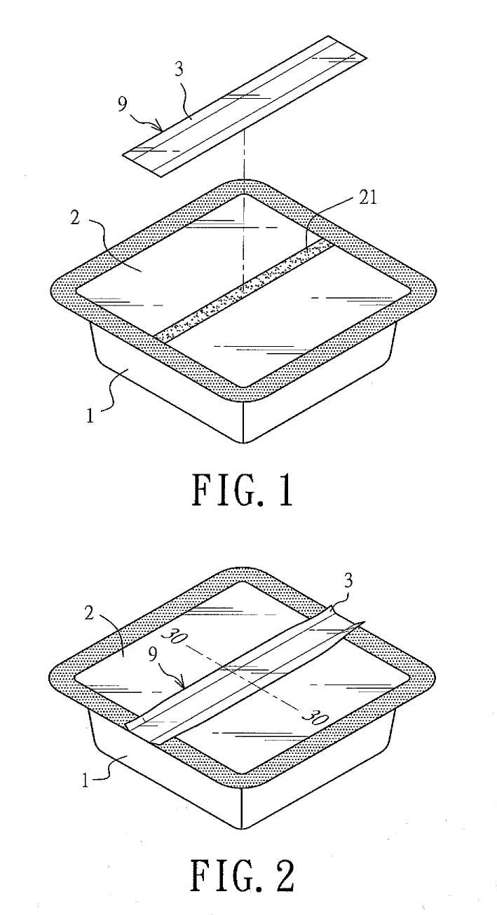

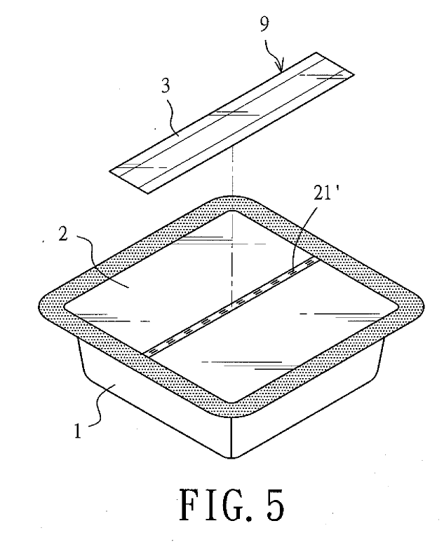

Referring now to FIGS. 1, 2 and 3, an airtight self-venting composite film for food packaging devices according to the present invention is illustrated. As shown, the composite film for packaging foods of the present invention is applied to a food packaging container 1 for packaging various frozen or refrigerated foodstuffs. A substrate film 2 having an impermeable property is attached to a rim of an opening of the food packaging container 1 by heat seal pressing to the flanges. Before attached to the food packaging container 1, the substrate film 2 is pre-formed with at least one micro-gap region 21 with predetermined range and dimension processed by a tooling method. In the preferred embodiment, the micro-gap region is arranged at random. Alternatively, the micro gaps are formed into discontinuous segmental micro gaps at the same direction, as micro-gap regions 21′ in FIG. 5. The micro-gap region 21 of the substrate film 2 is covered by a sealing adhesive tape 9 having a dimension greater than and dependent on the range of the micro-gap region 21. The sealing adhesive tape 9 consists of an airtight film 3 and an adhesive layer 4. The adhesive layer 4 is coated on partial area of one side surface of the airtight film 3 (in this embodiment, it is corresponding to the micro-gap region), as shown in FIG. 3. The adhesive layer 4 on one side of the airtight film 3 is correspondingly attached to and covered on the surface of the micro-gap region 21 of the substrate film 2, as shown in FIG. 2, so that the food packaging container 1, the substrate film 2, and the airtight film 3 to seal the micro-gap region 21 are combined into a unit.

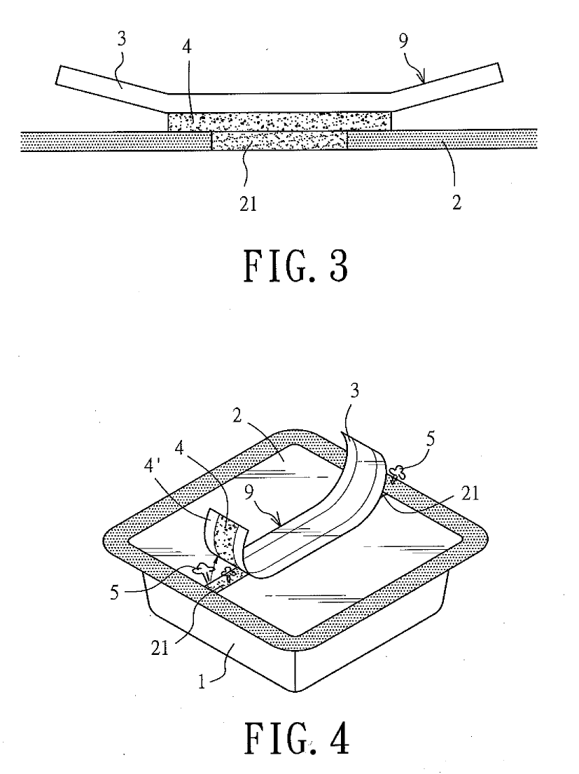

Referring now to FIG. 4, the food packaging container 1 hermetically sealed by the substrate film 2 is used to receive frozen or refrigerated foodstuffs During microwave heating, the foodstuffs are heated to generate a build-in high temperature pressurized steam, and the steam is dynamically regulated through the micro-gap region 21 of the substrate film 2 so that the adjacent adhesive layer 4 of the sealing adhesive tape 9 is gradually softened by contacting with hot steam 5 to decrease the adhesion strength gradually until the adhesive layer 4 of the sealing adhesive tape 9 are peeling off the substrate film 2 from two ends of the airtight film 3. Thus, a portion of the over high temperature pressurized steam 5 in the food packaging container 1 is dynamically regulated to the atmosphere through an exposed portion of the micro-gap region 21 where is not covered by the airtight film 3 so as to dynamically regulate the build-up high temperature pressurized steam 5 in the food packaging container 1 along the exposed portion of the micro-gap region 21 to prevent the air burst phenomenon to the food packaging container 1 while preserving most of the hot steam 5 in the food packaging container 1 and preventing the heated foods from becoming drier so as to maintain the original flavor thereof.

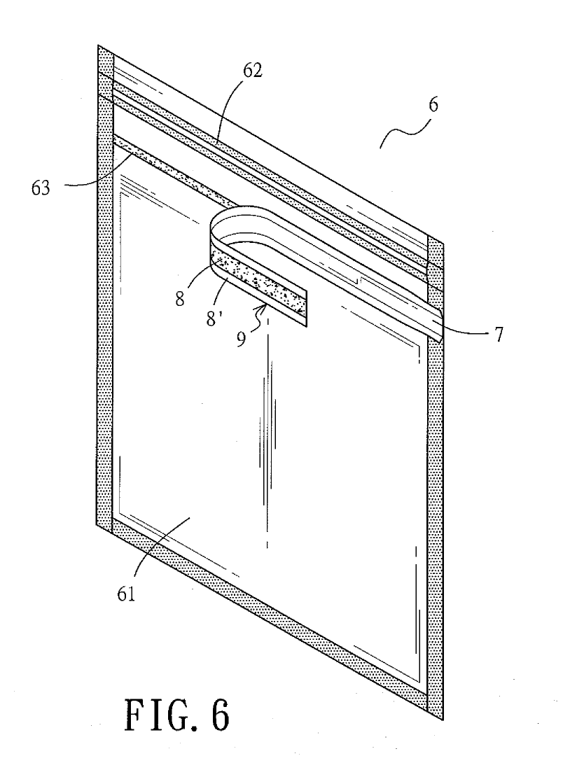

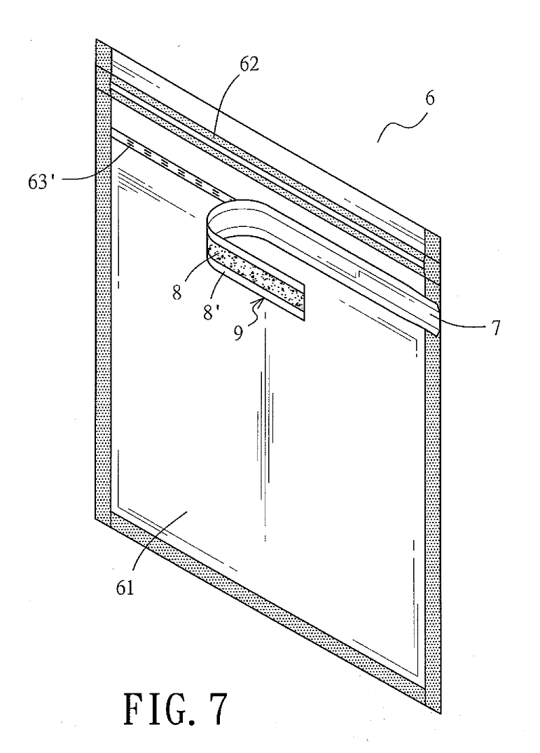

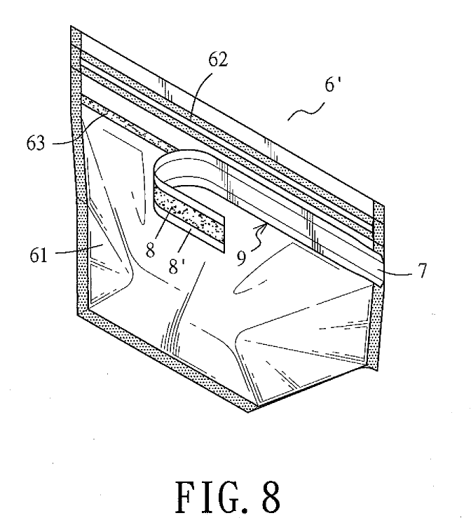

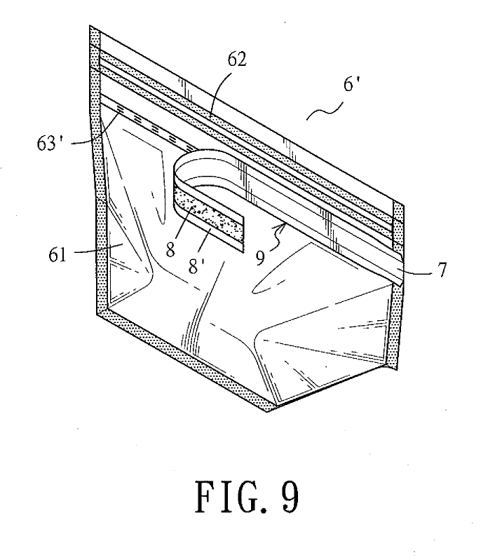

In a second embodiment, the airtight self-venting composite film for food packaging device of the present invention is used to manufacture a packaging bag 6 in another configuration, as shown in FIG. 6, or a tridimensional packaging bag 6′ as shown in FIG. 8. A substrate film 61 with a predetermined bag configuration is a body of the packaging bag 6 or 6′ having a heat-resistant and self-venting property. Moreover, the substrate film 61 is formed with an opening end having a reclosable profile 62, which is preferably selected from a zipper profile. After frozen or refrigerated foodstuffs are received in the food packaging bag 6, the reclosable profile 62 is convenient to selectively seal up the food packaging bag 6. The substrate film 61 with the self-venting area can be selectively used to form an entire structure or a portion of the food packaging bag 6 such as a side of the food packaging bag 6. Before shaped in the bag configuration, the substrate film 61 is pre-formed with at least one micro-gap region 63 with a predetermined range and dimension by an impression process. In this embodiment of FIG. 6, the micro-gap region is arranged at random. Alternatively, the micro gaps are formed into discontinuous segmental micro gaps at the same direction, as micro-gap regions 63′ in FIGS. 7 and 9. The micro-gap region 63 of the substrate film 61 is covered by a sealing adhesive tape 9 having a demension greater than and dependent on the range of the micro-gap region 63. The sealing adhesive tape 9 consists of an airtight film 7 and an adhesive layer 8. The adhesive layer 8 is coated on partial area of one side surface of the airtight film 7 (in this embodiment, it is corresponding to the micro-gap region). The adhesive layer 7 on one side of the airtight film 7 is correspondingly attached to and covered on the micro-gap region 63 of the substrate film 61 so that the substrate film 61 of the food packaging bag 6 and the airtight film 7 with the adhesive layer 8 are combined into a unit.

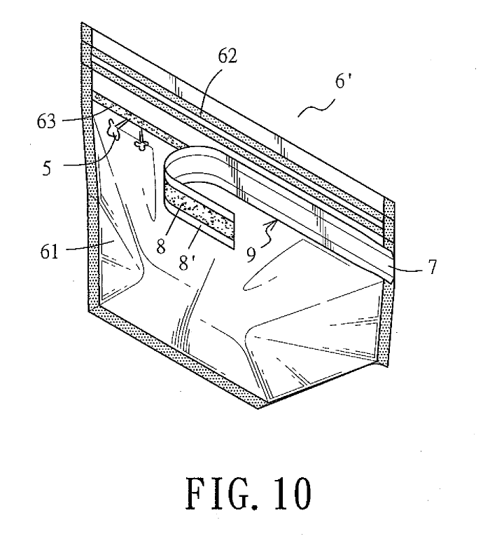

Referring now to FIG. 10, frozen or refrigerated foodstuffs are received in the packaging bag 6′ (here, the tridimensional packaging bag 6′ of FIG. 8 is used to be an illustration). During microwave heating, the foodstuffs are heated to generate build-in high temperature pressurized steam 5, and the build-up high temperature pressurized steam 5 is dynamically regulated through the micro-gap region 63 of the substrate film 61 so that the adjacent adhesive layer 8 is gradually softened by contacting with the high temperature pressurized steam 5 to gradually decrease the adhesion strength of the adhesive layer 8 until two ends of the adhesive layer 8.on the sealing adhesive tape 8 are peeling off the substrate film 61 from the airtight film 7. Thus, the over high temperature pressurized steam 5 in the food packaging bag 6′ is regulatingly released to the atmosphere through an exposed portion of the micro-gap region 63 where is properly separated from the airtight film 7 so as to dynamically regulate the build-in high temperature pressurized steam 5 generated with heat along the exposed portion of the micro-gap region 63 to prevent the air burst phenomenon of the packaging bag 6′ while retaining most of the hot steam in the food packaging bag 6 and preventing the heated foods from becoming drier to maintain the original flavor thereof.

The substrate film 2 (or 61) of the food packaging container 1 (or the food packaging bag 6) is made of at least one material selected from the group consisting of acrylic resin, polyester, polyethylene (PE), polypropylene (PP), polyamide, ethylene-styrene copolymer (ES), cyclo-olefin, polyethylene terephthalate (PET), polyvinyl alcohol (PVA), ethylene-vinyl acetate (EVA), ethylene vinyl alcohol (EVOH), ionomer, polyethylene naphthalate (PEN), poly ether ether ketone (PEEK), polycarbonate (PC), polysulfone, polyimide (PI), polyacrylonitrile (PAN), styrene acrylonitrile (SAN), polyurethane (PU), nylon, waxed paper, multi-layer co-extruded stretching film, synthetic paper, glassine paper, polyolefin-coated paper, paper, and the combination thereof.

The airtight film 3 or 7 attached to the micro-gap region 21, 21′, 63, or 63′ of the substrate film 2 of the packaging container 1 or the substrate film 61 of the packaging bag 6 or 6′ is made of at least one material selected from the group consisting of polyolefin, polyethylene (PE), polypropylene (PP), polyester film, polyethylene terephthalate (PET), polystyrene, polyvinyl chloride (PVC), polyethylene naphthalate (PEN), poly ether ether ketone (PEEK), polycarbonate (PC), polyimide (PI), polysulfone, polyacrylonitrile (PAN), acrylic resin, polyethylene-polypropylene copolymer, ethylene-styrene copolymer (ES), cyclo-olefin, polyvinyl alcohol (PVA), ethylene-vinyl acetate (EVA), ethylene vinyl alcohol (EVOH), styrene acrylonitrile (SAN), polyurethane (PU), nylon, polyamide, ionomer, synthetic paper, waxed paper, polyethylene non-woven fabric, polypropylene non-woven fabric, plastic film with inorganic dopant, multi-layer co-extruded stretching film, multi-layer composite, and the combination thereof.

Alternatively, the airtight film 3 or 7 is a multi-layer film which is selected from the group consisting of plastic film attached with a metal layer or plastic film vapor coated with a metal layer, wherein the metal layer therein can be selected from aluminum or aluminum alloy thereof.

The adhesive layer uniformly coated on the airtight film applied to the substrate film 2 of the packaging container 1 or the substrate film 61 of the packaging bag 6 or 6′ is made of at least one material selected from the group consisting of polyacrylic, polyester, polyolefin, polyethylene (PE), polypropylene (PP), cyclo-olefin, polyvinyl alcohol (PVA), ethylene-vinyl acetate (EVA), ethylene vinyl alcohol (EVOH), polyolefin derivative adhesive, polyamide, polyurethane (PU), styrene-butadiene copolymer, polyethylene-polypropylene copolymer, ethylene-styrene copolymer (ES), single-component primer, dual component primer, rubber, hot melt elastomer, silicone elastomer, ionomer, thermal plastic rubber, natural wax such as carnauba, paraffin, microcrystalline wax, propolis, and rice bran wax, man-made wax or synthetic wax derivated from polyethylene, polypropylene, poly(ethylene oxide), oxide of petrochemical substance, oxide of mineral oil, oxide of polyolefin, or oxide of wax, fatty acid, derivatives of fatty acid, starch, derivatives of starch, and the combination thereof. Furthermore, the adhesive layer may entirely or partially cover on the micro-gap region of the substrate film.

The area of the micro-gap region 21, 21′, 63 or 63′ may be entirely or partially distributed on a surface of the substrate film 2 of the food packaging container I or the substrate film 61 of the packaging bag 6 or 6′.

The adhesive layer on a side surface of the airtight film 3 or 7 applied to the substrate film 2 of the packaging container 1 or the substrate film 61 of the packaging bag 6 or 6′ may be coated by at least one coating method, such as coating an adhesive solution on the airtight film followed by drying; by directly coating a hot melt elastomer on the airtight film; or by hot pressing.

When using the packaging container or the packaging bag according to the present invention for packaging foods, the packed foods may comprise a solid like portion and a liquid like portion, both of which must be separated from each other in a preserved condition of room temperature, frozen condition, or refrigerated condition to prevent ruining the food due to a mixing with the solid like portion and the liquid like portion during preservation and transportation. To overcome the problem as described above, according to a preferred embodiment of the present invention, the liquid like portion of the foods can be pre-packed in an airtight packaging container or bag (not shown), and then the solid like portion of the foods and the liquid packaging container or bag can be commonly received in a food packaging device of the present invention, such as the food packaging container or the food packaging bag. Thereby, during microwave heating, a sealing film (not shown) of the liquid packaging container or bag will be softened and opened therefrom prior to the peeling function of the airtight film of the food packaging container or the food packaging bag so that the liquid like portion will be released from the liquid packaging container or bag to mix with the solid portion of the foods for commonly being heated.

When the packaging container or the packaging bag of the invention is applied to package oily food, high salinity food or food with water, the build-up pressure of the high temperature steam momentarily generated during microwave heating is excessive. It is better to remove the sealing adhesive tape 9 from the food packaging container or the food packaging bag for safety, so that the excess build-up steam pressure can be dynamically regulated through the micro-gap region to prevent the container or bag from breaking.

The present invention has been explained and illustrated in the preferred embodiments as described above while not limiting to the preferred embodiments. In another aspect, the self-venting composite film of the present invention can be selectively formed in various structures such as back sealed bags, gadget bags, three-sides seal bags, standup pouches, and etc.

The food packaging container or the food packaging bag according to the present invention has the following advantages:
a) The airtight food packaging device according to the present invention can be applied to food with liquid materials, such as soup and sauce with no leakage concern.
b) The sealing adhesive tape covering on the micro-gap region of the substrate film is reusable.
c) Ice burn phenomenon due to water evaporation caused by storage in a dry open space at a long-term period can be infallibly avoided.
d) The self-venting food packaging device according to the present invention can be provided in microwaveable vacuum packaging application.
e) The adhesive layer of the sealing adhesive tape of the self-venting food packaging device can be attached to and cover on the plurality of micro-gap region and the unglued area of the airtight film facilitates peeling the sealing adhesive tape off the substrate film for reuse.
f) The self-venting food packaging device according to the present invention is characteristic of double pressure cooking mechanism, which can shorten the heating time for cooking.
g) The self-venting food packaging device according to the present invention is a soft packaging device using green technology which is able to be provided in microwaveable heating procedure with higher energy efficiency, different from conventional products with low energy efficiency.
h) The food packaging device according to the present invention maintains an airtight state during storage and transportation so that flavor of foodstuffs will not leak out, and insects, such as ants, are kept away so that shelf life of food is longer.
i) The food packaging device according to the present invention takes less storage space and is less weight and convenient than metal cooking utensils.
j) The food packaging device according to the present invention provides a consuming microwaveable cooking food bag for household and kitchen use.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An airtight self-venting composite film for food packaging device, characterized in that the composite film comprises at least:
a substrate film formed with a plurality of micro-gap regions formed by impressing process; and
a sealing adhesive tape for covering the micro-gap region of the substrate film including an airtight film which has partial area of one side surface coated with an adhesive layer correspondingly attached to and covered on the surface of the micro-gap regions of the substrate film and rest area without coating the adhesive layer for facilitating peeling the sealing adhesive tape off;
wherein the composite film applied to the food packaging device for receiving frozen or refrigerated foodstuffs maintains an airtight state under a room temperature condition or a frozen or refrigerated condition, build-up high temperature pressurized steam evaporated from the heated foodstuffs sealed in the food packaging device will be regulated through the plurality of micro-gap regions of the substrate film during microwave heating and be in contact with the surface of the adhesive layer adjacent to the substrate film so that the adhesive layer is gradually softened by the hot steam and the strength of adhesion is gradually decreased till the airtight film being peeling off the substrate film, and a ventilation channel is formed therefore so as to dynamically regulate the build-up high temperature pressurized steam to prevent air burst phenomenon and avoid foodstuffs therein becoming too dried and hard.

2. The composite film of claim 1, characterized in that said substrate film is made of at least one material selected from the group consisting of acrylic resin, polyester, polyethylene, polypropylene, polyamide, ethylene-styrene copolymer, cyclo-olefin, polyethylene terephthalate, polyvinyl alcohol, ethylene-vinyl acetate, ethylene vinyl alcohol, ionomer, polyethylene naphthalate, poly ether ether ketone, polycarbonate, polysulfone, polyimide, polyacrylonitrile, styrene acrylonitrile, polyurethane, nylon, waxed paper, multi-layer co-extruded stretching film, synthetic paper, glassine paper, polyolefin-coated paper, paper, and the combination thereof.

3. The composite film of claim 1, characterized in that said airtight film is made of at least one material selected from the group consisting of polyolefin, polyethylene, polypropylene, polyester film, polyethylene terephthalate, polystyrene, polyvinyl chloride, polyethylene naphthalate, poly ether ether ketone, polycarbonate, polyimide, polysulfone, polyacrylonitrile, acrylic resin, polyethylene-polypropylene copolymer, ethylene-styrene copolymer, cyclo-olefin, polyvinyl alcohol, ethylene-vinyl acetate, ethylene vinyl alcohol, styrene acrylonitrile, polyurethane, nylon, polyamide, ionomer, synthetic paper, waxed paper, polyethylene non-woven fabric, polypropylene non-woven fabric, plastic film with inorganic dopant, multi-layer co-extruded stretching film, multi-layer composite, and the combination thereof.

4. The composite film of claim 1, characterized in that said airtight film is selected from the group consisting of a plastic film attached with a metal layer or a plastic film vapor coated with a metal layer.

5. The composite film of claim 4, characterized in that said metal layer is selected from aluminum or aluminum alloy thereof.

6. The composite film of claim 1, characterized in that said adhesive layer is made of at least one material selected from the group consisting of polyacrylic, polyester, polyolefin, polyethylene, polypropylene, cyclo-olefin, polyvinyl alcohol, ethylene-vinyl acetate, ethylene vinyl alcohol, polyolefin derivative adhesive, polyamide, polyurethane, styrene-butadiene copolymer, polyethylene-polypropylene copolymer, ethylene-styrene copolymer, single-component primer, dual component primer, rubber, hot melt elastomer, silicone elastomer, ionomer, thermal plastic rubber, natural wax, carnauba, paraffin, microcrystalline wax, propolis, rice bran wax, polyethylene synthetic wax, polypropylene synthetic wax, poly(ethylene oxide) synthetic wax, synthetic wax of oxide of petrochemical substance, synthetic wax of oxide of mineral oil, synthetic wax of oxide of polyolefin, synthetic wax of oxide of wax, fatty acid, derivatives of fatty acid, starch, derivatives of starch, and the combination thereof.

7. The composite film of claim 1, characterized in that the food packaging device for receiving frozen or refrigerated foodstuffs is a food packaging container or a food packaging bag.

8. The composite film of claim 1, characterized in that said substrate film is entirely or partially formed with the plurality of micro-gap regions.

9. The composite film of claim 1, characterized in that said adhesive layer is entirely or partially attached to and covered on the plurality of micro-gap regions of the substrate film.

10. The composite film of claim 1, characterized in that the airtight film of the scaling adhesive tape having a dimension greater than and dependent on that of the distribution range of the micro-gap regions of the substrate film.
